(19) United States
(12) Patent Application Publication
(10) Pub. No.: US 2005/0197922 A1
(43) Pub. Date: Sep. 8, 2005

(54) Method and system for accessing and printing access-controlled photographs using a public computer network

(76) Inventors: Peter Pezaris, Delray Beach, FL (US); Michael Gersh, Delray Beach, FL (US)

Correspondence Address: PEPPER HAMILTON LLP, ONE MELLON CENTER, 50TH FLOOR, 500 GRANT STREET, PITTSBURGH, PA, 15219, US

(21) Appl. No.: 10/993,001

(22) Filed: Nov. 19, 2004

Related U.S. Application Data
(63) Continuation-in-part of application No. 10/793,240, filed on Mar. 4, 2004.
(63) Continuation-in-part of application No. 10/793,233, filed on Mar. 4, 2004.

(51) Int. Cl. G06F 17/60

(52) U.S. Cl. 705/27

(57) ABSTRACT

A method and system for accessing and having access-controlled photographs printed is disclosed. A user posting one or more photographs may set access control criteria restricting the set of other users who may display the photographs, print the photographs and/or have the photographs printed. A social networking environment may compare a second user's information with the access control criteria to determine if the second user has access rights. The access control criteria may include a relationship designator, a group designator, a tier designator, a proximity index, a geographical location, and/or a family name. An accessing user may have one or more photographs printed by a print service. The user may set print and delivery options for the photographs, individually or collectively. The social networking environment may provide the photographs to the print service, which prints and delivers the photographs according to the print and delivery options.

### CLAIM OF PRIORITY

This application is a continuation-in-part of and claims priority to U.S. patent application Ser. No. 10/793,240, filed Mar. 4, 2004, entitled “Method and System for Associating a Thread with Content in a Social Networking Environment,” and U.S. patent application Ser. No. 10/793,230, filed Mar. 4, 2004, entitled “Method and System for Controlling Access to User Information in a Social Networking Environment,” which are incorporated herein by reference in their entireties.

### TECHNICAL FIELD

The present invention generally relates to having photographs subject to access control printed using a public computer network. Specifically, the invention relates to accessing and printing access-controlled photographs in a social networking environment. The access-controlled photographs are loaded into the social networking environment by a first user who optionally permits one or more of a group of second users in the first user's social network or in the social networking environment to access the photographs, print the photographs and/or have the photographs printed. If the first user assigns display access control criteria, a second user can only access the photographs if the second user's display information corresponds to the display access control criteria. If the first user assigns print access control criteria, a second user can only print the photographs and/or have the photographs printed if the second user's print information corresponds to the print access control criteria.

### BACKGROUND

Individuals form social networks of other individuals for a variety of reasons. Most people develop personal networks that include friends, acquaintances, and the like as a means of obtaining social interaction. In addition, people develop professional networks that include co-workers, managers, vendors, clients and the like as a means of enhancing their professional life. A person may use his personal or professional networks (individually or collectively, a person's social network) to, for example, obtain dates, enhance job searches or form a guest list for an event.

A person may attempt to expand his social network by attending social functions or conferences in order to meet new people, by requesting that someone within the person's social network introduce the person to someone outside of the person's social network, or by simply meeting someone on the street. Generally, such expansions of a person's social network require that the two people physically come in contact or at least that the two coordinate to engage in conversation at the same time. Hence, such social network expansion may be time-intensive and require substantive effort on the part of the person seeking to expand his social network.

The introduction of the Internet has provided an additional medium for expanding one's social network. Chat rooms, message boards, and interactive Web sites each provide the opportunity for people to meet other people and expand their social networks. Moreover, information may be transmitted from one person to another over the Internet by posting the information on a Web site or by sending an e-mail message to another person's e-mail address. Because the Internet allows users to interact with individuals that are remotely located, the Internet can provide a powerful tool in expanding a person's social network.

In addition, Internet users need not be online at the same time in order to share information or develop a personal contact. For example, one user may send an e-mail message to a second user while the second user is not present at his computer. Despite being remotely located and not being online at the same time, the information may still be transmitted to the second individual.

Accordingly, computers and the Internet have increasingly become tools that allow people to interact with one another and to meet new people. E-dating Web sites, social networking Web sites, which are either social or professional in nature, and other similar services have been developed to meet this need.

One problem with these services is that they do not provide an organized method for transferring information, such as photographs, within the service to a plurality of known users simultaneously. Another problem is that a photograph, once posted on a Web site, is typically available to all users of the Web site. Because refined access control is unavailable, a user might not post a photograph on a Web site if the user does not want all of its users to be able to view the photograph. This can restrict the flow of information. Moreover, a user might wish that certain users be able to see the photograph, but not be able to print it. This may occur because the user wishes to control a copyrighted work. Additional levels of access control are also possible.

What is needed is a method and system for providing refined access control for a user posting a photograph to a Web site.

A further need exists for a method and system for providing refined access control to determine one or more users that can print a photograph from a Web site using, for example, a third party print service.

A further need exists for a method of permitting a user to print another user's access-controlled photograph using a third party print service.

The present disclosure is directed towards solving one or more of these problems.

### SUMMARY OF THE INVENTION

Before the present methods, systems, and materials are described, it is to be understood that this invention is not limited to the particular methodologies, systems and materials described, as these may vary. It is also to be understood that the terminology used in the description is for the purpose of describing the particular versions or embodiments only, and is not intended to limit the scope of the present invention which will be limited only by the appended claims.

It must also be noted that as used herein and in the appended claims, the singular forms “a,” “an,” and “the” include plural references unless the context clearly dictates otherwise. Thus, for example, reference to a “photograph” is a reference to one or more photographs and equivalents thereof known to those skilled in the art, including digital pictures, GIF files, BMP files, JPEG files and so forth. Unless defined otherwise, all technical and scientific terms used herein have the same meanings as commonly understood by one of ordinary skill in the art. Although any methods, materials, and devices similar or equivalent to those described herein can be used in the practice or testing of embodiments of the present invention, the preferred methods, materials, and devices are now described. All publications mentioned herein are incorporated by reference. Nothing herein is to be construed as an admission that the invention is not entitled to antedate such disclosure by virtue of prior invention.

In an embodiment, a method for controlling access rights to one or more photographs in a social networking environment includes receiving, from a first user, print access control criteria for one or more photographs posted by the first user in a social networking environment, and permitting the second user to have at least one of the photographs printed if print information for a second user with respect to the first user corresponds to the print access control criteria. The method may further include preventing the second user from having the photographs printed if the print information for the second user does not correspond to the print access control criteria. The print access control criteria may include one or more of a relationship designator, a group designator, a tier designator, a proximity index, a geographic location, and a family name. The print information may include one or more of a relationship designator, a group designator, a tier designator, a proximity index, a geographic location, and a family name. The method may further include receiving, from a first user, display access control criteria for the one or more photographs, and permitting at least one of the photographs to be displayed to the second user if display information for a second user with respect to the first user corresponds to the display access control criteria. The method may further include preventing the second user from accessing the photographs if the display information for the second user does not correspond to the display access control criteria. The display access control criteria may include one or more of a relationship designator, a group designator, a tier designator, a proximity index, a geographic location, and a family name. The display information may include one or more of a relationship designator, a group designator, a tier designator, a proximity index, a geographic location, and a family name.

In an embodiment, a method for enabling the printing of access-controlled photographs posted in a social networking environment includes displaying one or more photographs posted by a first user in a social networking environment, receiving a first request to have at least one photograph printed, receiving a second request to assign one or more print options for each photograph requested by the first request, receiving a third request to assign one or more delivery options for the at least one photograph requested by the first request, and providing the at least one photograph requested by the first request to a print service. The first request may be received from a second user. The one or more print options may include one or more of a print finish option, a cropping option, one or more quantities to have printed for each photograph requested by the first request, one or more print sizes for each photograph requested by the first request, and a quantity to have printed for each photograph requested by the first request for each of one or more print sizes. The second request may be received from a second user. The one or more delivery options may include one or more of a billing address, a delivery address, a shipping method, and a payment method. The third request may be received from a second user. The method may further include receiving a first payment for having the at least one photograph requested by the first request printed. The method may further include transmitting a second payment to the print service for printing the at least one photograph requested by the first request. In an embodiment, providing the at least one photograph requested by the first request may include transmitting the at least one photograph to a print service. The method may further include printing, by the print service, the at least one provided photograph based on the one or more print options, and delivering the at least one printed photograph based on the one or more delivery options.

In an embodiment, a method for having access-controlled photographs printed in a social networking environment printed includes determining, by a social networking environment, whether a user has a right to access at least one photograph; displaying the at least one photograph to the user if the user has the right to access the at least one photograph; receiving, by the social networking environment, a request from the user to have one or more access-controlled photographs printed; receiving, by the social networking environment, one or more print options for printing the one or more photographs and one or more delivery options for delivering at least one print of the one or more photographs; providing the one or more photographs to a print service; printing, by the print service, the one or more photographs based on the one or more print options; and delivering the one or more prints of the one or more photographs based on the one or more delivery options.

In an embodiment, a system for controlling access rights to one or more photographs in a social networking environment includes a processor, a computer-readable storage medium in communication with the processor, a communications network operably connected to the processor, and a plurality of computer systems operably connected to the communications network. The computer-readable storage medium may contain one or more programming instructions for performing a method for controlling access rights to one or more photographs in a social networking environment including receiving, from a first user, print access control criteria for one or more photographs posted by the first user in a social networking environment, and permitting the second user to have at least one of the photographs printed if print information for a second user with respect to the first user corresponds to the print access control criteria. The computer-readable storage medium may further contain one or more programming instructions for receiving, from a first user, display access control criteria for the one or more photographs, and permitting the second user to display at least one of the photographs if display information for a second user with respect to the first user corresponds to the display access control criteria.

In an embodiment, a system for enabling the printing of access-controlled photographs posted in a social networking environment including a processor, a computer-readable storage medium in communication with the processor, a communications network operably connected to the processor, and a plurality of computer systems operably connected to the communications network. The computer-readable storage medium may contain one or more programming instructions for performing a method for enabling the printing of access-controlled photographs posted in a social networking environment including displaying one or more photographs posted by a first user in a social networking environment, receiving a first request to have at least one photograph printed, receiving a second request to assign one or more print options for each photograph requested by the first request, receiving a third request to assign one or more delivery options for each photograph requested by the first request, and providing each photograph requested by the first request to a print service.

In an embodiment, a system for having access-controlled photographs printed in a social networking environment printed includes a processor, a computer-readable storage medium in communication with the processor, a communications network operably connected to the processor, and a plurality of computer systems operably connected to the communications network. The computer-readable storage medium may contain one or more programming instructions for performing a method for having access-controlled photographs printed in a social networking environment printed including determining, by a social networking environment, whether a user has a right to access at least one photograph; displaying the at least one photograph to the user if the user has the right to access the at least one photograph; receiving, by the social networking environment, a request from the user to have one or more access-controlled photographs printed; receiving, by the social networking environment, one or more print options for printing the one or more photographs and one or more delivery options for delivering at least one print of the one or more photographs; providing the one or more photographs to a print service; printing, by the print service, the one or more photographs based on the one or more print options; and delivering the one or more prints of the one or more photographs based on the one or more delivery options.

### BRIEF DESCRIPTION OF THE DRAWINGS

The accompanying drawings, which are incorporated in and form a part of the specification, illustrate embodiments of the present invention and, together with the description serve to explain the principles of the invention. The embodiments illustrated in the drawings should not be read to constitute limiting requirements, but instead are intended to assist the reader in understanding the invention.

FIG. 1 depicts an exemplary photograph album listing based on access control criteria in a social networking environment according to an embodiment.

FIG. 2 depicts an exemplary access control screen for a photograph album in a social networking environment according to an embodiment.

FIG. 3 depicts an exemplary photograph album in a social networking environment according to an embodiment.

FIG. 4 depicts an exemplary photograph selection screen according to an embodiment.

FIG. 5 depicts an exemplary photograph print option selection screen according to an embodiment.

FIG. 6 depicts an exemplary shipping information screen according to an embodiment.

FIG. 7A depicts an exemplary method of providing access control according to an embodiment.

FIG. 7B depicts an exemplary method for having one or more photographs printed from a social networking environment according to an embodiment.

FIG. 8 depicts a block diagram of exemplary internal hardware that may be used to contain or implement program instructions according to an embodiment.

### DETAILED DESCRIPTION

In an embodiment, users may have photographs subject to access control printed from a social networking environment via a public computer network. In an embodiment, at least one of the users did not post the photographs to the social networking environment. A first user may load the access-controlled photographs into the social networking environment. The first user may permit one or more of a group of second users to access the photographs and/or have the photographs printed. A second user may be a member of the first user's social network or the social networking environment in general. The second user may access the photographs and/or have the photographs printed depending upon the access granted to the second user.

A social networking environment may permit a plurality of users to interact with each other. Moreover, the social networking environment may permit its users to describe relationships (as defined below) with other users. A user's social network may include one or more users with whom a particular user has a relationship, one or more users having relationships with the one or more users with whom the particular user has a relationship, and so on.

A relationship is a set of one or more connections between a first user and a second user. Each connection is a particular path connecting the first user and the second user within a social networking environment. A connection is either direct (i.e., no intervening users between the first user and the second user) or indirect (i.e., at least one intervening user between the first user and the second user). Each connection includes one or more direct connections (also known as “steps”). Each step may include a relationship designator (as defined below). A tier is the set of users who are an equal number of steps away from a particular user. Thus, a first user's second tier includes all users who are two steps away from the first user.

A social networking environment may permit its users to post photographs for display to other users. In addition, the user posting the photographs and other users provided with appropriate access rights may have one or more of the photographs printed by a third party print service. The social networking environment may further allow the user posting the photographs and other users provided with appropriate access rights to print one or more of the photographs themselves. A method and system for assigning access rights to photographs for the purpose of printing one or more of the photographs, a method and system for printing access-controlled photographs posted in a social networking environment, and a method and system for printing access-controlled photographs via a third party service, are described below.

Access Control

Access control permits a first user to determine which of a group of second users in a social networking environment can access or print particular photographs posted by, for example, the first user. The social networking environment may provide the first user with the ability to use user-defined or system-generated parameters to control access to the photographs. Such parameters may include, for example, relationship designators, group designators, tier designators and proximity indices. These parameters are described in further detail below.

Relationship Designators

User defined parameters for access control in a social networking environment may include at least one relationship designator defining a connection between a user and a contact (i.e., a first tier individual in conventional social networking environments). Relationship designators may include, but are not limited to, one or more of familial relationship designators, friendship relationship designators, co-worker relationship designators and business associate relationship designators. Familial relationship designators may include, but are not limited to, wife, husband, mother, father, mother-in-law, father-in-law, daughter, son, daughter-in-law, son-in-law, sister, brother, sister-in-law, brother-in-law, grandmother, grandfather, granddaughter, grandson, cousin, second cousin, aunt, uncle, nephew, niece, stepmother, stepfather, stepsister, stepbrother, stepson, stepdaughter, ex-wife, ex-husband, friend of the family, distant relative, other relative and life partner. Friendship relationship designators may include, but are not limited to, fiance, girlfriend, boyfriend, friend, roommate, neighbor, sorority sister, fraternity brother and classmate. Co-worker relationship designators may include, but are not limited to, co-worker, manager, employee and business partner. Business associate relationship designators, but are not limited to, may include vendor, supplier, client, contractor and business contact. In an embodiment, additional or alternate relationship designators may be used for a social networking environment. In an embodiment, alternate or additional categories of relationship designators may be used. In an embodiment, relationship designators may be grouped in different categories.

In an embodiment, a relationship between a user and an individual may include more than one connection. For example, the user may be each of a friend, a fraternity brother, a classmate and a business partner of the individual. In such an embodiment, the user may establish a plurality of connections to appropriately describe the relationship between the user and the individual. The social networking environment may require the individual to separately confirm each connection in order to describe the relationship between the user and the individual accurately.

In an embodiment, the user may assign one or more relationship designators to an individual when the individual is added as a contact. The individual may receive a message from the social networking environment stating that the user would like to add the individual as a contact. In an embodiment, the social networking environment may automatically assign a second relationship designator based upon the first relationship designator assigned by the user to the individual and the genders of each of the user and the individual. For example, a male user may assign the relationship designator of “girlfriend” to a female contact. Upon acceptance of the contact relationship by the female contact, the social networking environment may automatically assign a relationship designator of “boyfriend” to the male user in the female contact's social network. In an embodiment, the social networking environment may automatically assign corresponding relationship designators for a subset of all relationship designator types, such as familial relationships. In an embodiment, the social networking environment may permit an individual to assign his or her own relationship designators to a contacting user when accepting an invitation to form a relationship or after such acceptance.

In the case where the individual to which the user assigns one or more relationship designators is not a user of the social networking environment, the individual may be required to become a user before the individual is added as a contact of the first user. In the case where the individual is already a user of the social networking environment, the environment may relate the user to the individual upon receipt of the individual's affirmative response to the user's request.

A relationship designator may be combined with a tier designator (described below) to denote a relationship within a social networking environment. For example, the user may state that content is available to all “second tier friends.” In an embodiment, the designation “second tier friends” may make content available to the friends of each of the user's contacts and, optionally, the user's contacts. In an alternate embodiment, the designation “second tier friends” may make content available to friends of each of the user's friends and, optionally, the user's friends. Additional designations and/or more particular designations may be made using embodiments of the present invention.

Group Designators

User defined parameters for access control in a social networking environment may further include a group designator. One or more users may be members of a group associated with the group designator. In an embodiment, group designators are a subset of relationship designators. A group designator may operate as a user-defined relationship designator.

A user may create a group in a social networking environment, assign a group designator to the group and invite other users to become members of the group. A user that controls the operation of the group is referred to herein as the “manager.” Other users in the group are referred to herein as “members.” The manager is also typically a member. Users who have been invited to join the group are referred to herein as “pending members.”

In an embodiment, the manager may create the group by, for example, clicking on a link to create a new group and assigning a group name to the group. Assigning the group name may further include assigning a group identifier. Once created, the manager may invite other users to become members of the group. A message may be transmitted to the pending members stating that the manager has requested their acceptance of group membership. Pending members may then accept or deny membership in the group. In an embodiment, members may invite other users to join the group.

Group members may interact within the social networking environment by sending messages to or posting content for other group members. Groups may be created for any purpose. Exemplary groups include, without limitation, scout troops, airplane enthusiasts, fraternity brothers, fans of a musical group and the like.

A user may combine a group designator with a tier designator (described below) to control access to a photograph within a social networking environment. For example, the user may state that the photograph is available to “my airplane enthusiast club's family.” In an embodiment, the designation “my airplane enthusiast club's family” makes the photograph available to the family members of each member of the airplane enthusiast club. In an embodiment, the designation “my airplane enthusiast club's family” also makes the content available to the members of the airplane enthusiast's club. Additional designations and/or more particular designations may be made using embodiments of the present invention.

Tier Designators

A tier designator may represent the shortest distance between two individuals. For example, if a first user is a friend of a second user, who is the wife of a third user, who is a co-worker of a fourth user, then the first user is in the third tier of the fourth user's social network. Likewise, the fourth user is in the third tier of the first user's social network. If the first user is additionally the manager of a fifth user, who is a friend of the fourth user, then the first user and the fourth user would each be in the second tier of the other user's social network based on their relationship via the fifth user.

Tier designators may provide one measure used to determine a proximity index (described below). In addition, tier designators may be combined with one or more relationship designators to assist in defining the strength of a relationship between two users. The use of tier designators in combination with relationship designators is described above.

Proximity Index

A social networking environment may determine proximity indices between users of the environment. A proximity index measures the closeness of the relationship between two users of the environment. Proximity indices may permit a user to manage access to photographs by appropriately presenting the photographs to the proper audience.

A user may use a system-generated proximity index as a parameter to determine the individuals that receive specific photographs from the user. The user may set a proximity index threshold for all photographs created by the user, all photographs of a particular type, all photographs in a particular album or a particular photograph.

In an embodiment, the social networking environment may generate the proximity index from one or more of the following pieces of information:
The number of tiers or degrees separating the individuals;
The number of distinct paths between two individuals (e.g., a first user may be the wife of a second user and a friend to a third user, where the second and third users are friends of a fourth user and where the proximity is generated from the first user to the fourth user);
The relationship type between two individuals (e.g., wife/husband vs. cousin/cousin);
The number of relationship types between two individuals (e.g., a first user may be both a friend and a co-worker of a second user);
Whether the individuals share membership in the same group, taking into account, for example, a group type (e.g., public or private) and the size of the group;
Whether actual communication has occurred between the two individuals;
Whether actual communication has occurred between shared contacts of the two individuals;

Other or additional information may be used to compute the proximity index.

The proximity index may be, for example, a numerical value between 0 and 1, inclusive. In an embodiment, a proximity index of 1 represents the relationship of a user to himself and may not be achievable between two distinct users.

The social networking environment may map ranges of numerical proximity index values to user-discernable labels. In an embodiment, a numerical proximity index between 0.800 and 0.999 may map to a proximity index label of “Very Close;” a numerical proximity index between 0.600 and 0.799 may map to a proximity index label of “Close;” and a numerical proximity index between 0.400 and 0.599 may map to a proximity index label of “Distant.” In an embodiment, a numerical proximity index less than 0.400 may not receive a proximity index label because the relationship between the two users is too tenuous. The above-listed numerical ranges and proximity index labels are exemplary only. Any numerical range, number of proximity index labels and/or proximity index label designators may be used for the proximity index labels.

A social networking environment may use the labels and associated icons to enable users to quickly modify settings and identify the proximity of other users. A user may elect to filter his messages based on the proximity of the sender to the user, such as only viewing messages from people in the user's social network who are “Very Close” or “Close.”

Other criteria may also be used to control access to photographs. For example, a user may restrict access to all users that live within a certain radius of the user's location, have the same last name or have any other item of personal information in common. Accordingly, the social networking environment may enable the user to permit users to view photographs if they have similar interests even if they are unknown to the user. Such access control may assist a user in forming a group or finding someone with similar interests who lives nearby.

Photographs

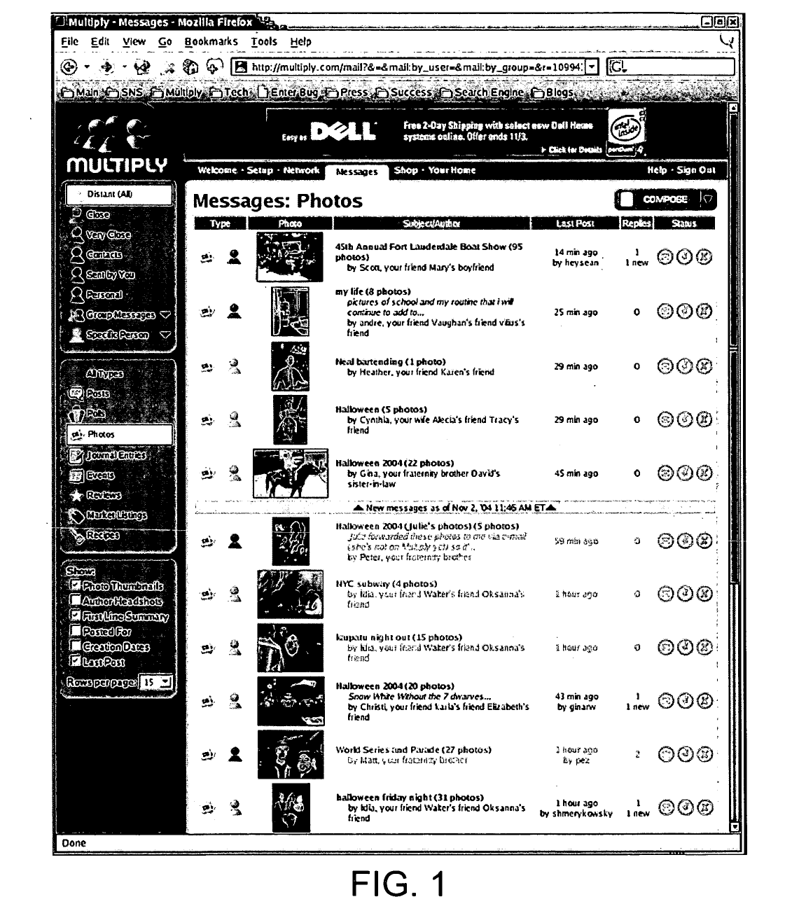

FIG. 1 depicts an exemplary photograph album listing based on access control criteria in a social networking environment according to an embodiment. A first user may create a photograph album to display photographs to one or more second users. When a second user accesses the first user's photograph page within the social networking environment, the second user may be presented with a list of the first user's photograph albums. The list of photograph albums may not include all photograph albums produced by the first user due to access control placed on the photographs by the first user. For example, if the second user has a Distant relationship with the first user, the second user may not be able to access photograph albums designated only for users who are Close or Very Close. In an embodiment, if a user accesses his own photograph page, photograph album or photograph, the social networking environment may permit the user to perform additional functions related to managing albums and photographs, such as, for example, uploading, editing or deleting photographs or photograph albums.

Each photograph album may have a set of links associated with it that only an owner of the photograph album may access. In an embodiment, these links may permit the owner to edit the photograph album, publish the photograph album, delete the photograph album and upload a photograph to the photograph album. Editing the photograph album may allow the user to change album properties, such as, for example, the name of the photograph album, the cover image of the photograph album, a description of the album, a proximity threshold for accessing the photograph album, a proximity threshold for printing photographs from the photograph album, and an ability to determine whether viewers may post comments on the photograph album. Publishing the photograph album may generate a notification message to all users having access to the photograph album. The owner of the photograph album and, if permitted by the owner, other users having access to the photographs may post comments pertaining to the photographs in the photograph album. Deleting the photograph album may remove a photograph album and its associated photographs from the social networking environment. Uploading a photograph may allow the owner to associate a photograph with a photograph album. In an embodiment, group members may be allowed to upload photographs if permitted by the group manager. The group manager may determine members that may upload photographs based on setting a proximity threshold as described above.

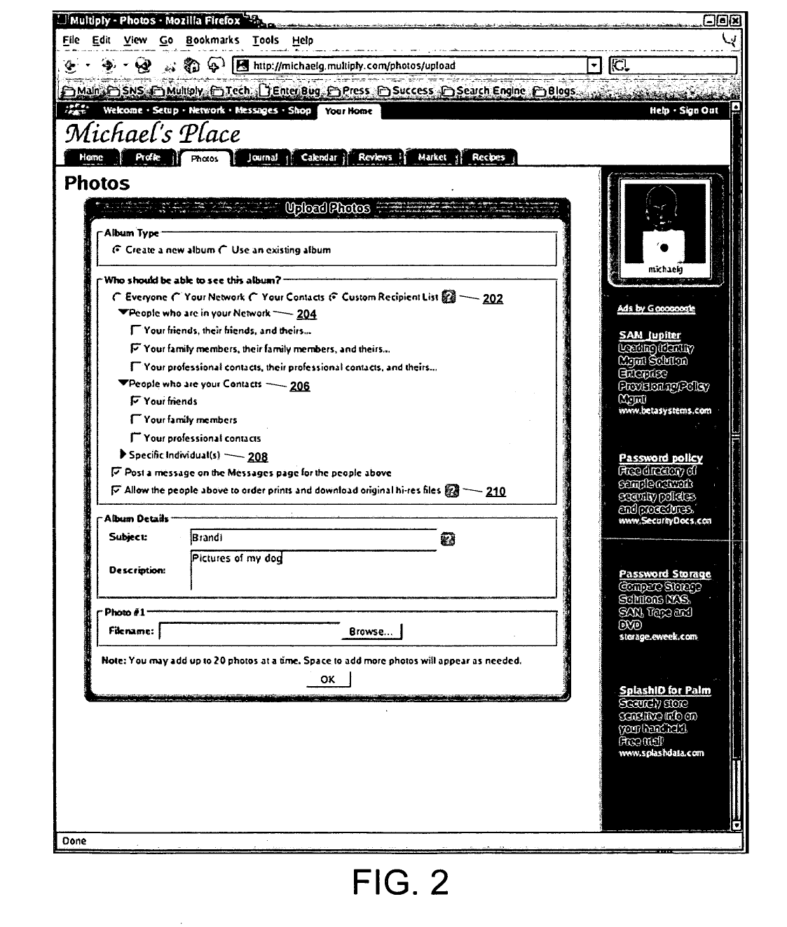

FIG. 2 depicts an exemplary access control screen for a photograph album in a social networking environment according to an embodiment. A proximity threshold may be set, for example, by accessing one or more checklists and/or pulldown menus to determine the type of relationship(s) required to access a particular photograph or photograph album.

In an embodiment, a first user may select one or more users who may view the photograph album. For example, the first user may enable 202 every user of the social networking environment, users in the first user's social network, users that are contacts of the second user, users having particular relationships to the first user, and/or particular users to access the photograph album via a display access control list. If the first user elects to define the particular relationships for those who may view the photograph album, the first user may define the relationships based on one or more options presented to the first user.

In an embodiment, the display access control list may include selections for users in the first user's network 204, users in the first user's list of contacts 206, and/or specific individuals 208. In an embodiment, options for users in the first user's network 204 may include friends (and friends of friends, friends of friends of friends, etc.), family members (and family members of family members, etc.), and/or professional contacts (and professional contacts of professional contacts, etc.). In an embodiment, options for users in the first user's list of contacts 206 may include first-tier friends, family members, and/or professional contacts. In an embodiment, the first user may specify specific individuals 208 by entering a user's social networking environment identifier, a user's name, and/or other designations. Other options and groupings for defining users who may access a photograph album are also possible and envisioned within the scope of this disclosure.

The first user may then choose 210 to allow the users who can display the photographs to print photographs from the album or have photographs printed from the album. In an alternate embodiment, the social networking environment may provide additional access control criteria to allow the first user to define a group of users who can print photographs or have photographs printed (i.e., a print access control list) from the group of users who can view the photograph album. The print access control list may be displayed on the same screen as the display access control list or on a separate screen.

Printing

In an embodiment, an owner of a photograph album may set access control criteria to determine which users are permitted to print photographs posted by the owner. The owner may set global access control criteria pertaining to all photographs posted by the owner. In addition, the owner may set access control criteria pertaining to a particular photograph album or photograph. Other levels of access control are also possible within the scope of this invention.

Users having a relationship with the owner of a photograph that is encompassed within the defined access control criteria for having a photograph printed may be presented with an option to have a photograph printed when viewing the photograph; have a photograph album or one or more photographs printed when viewing a photograph album; or have all photographs, one or more photograph albums or one or more photographs printed when viewing the owner's photograph Web page.

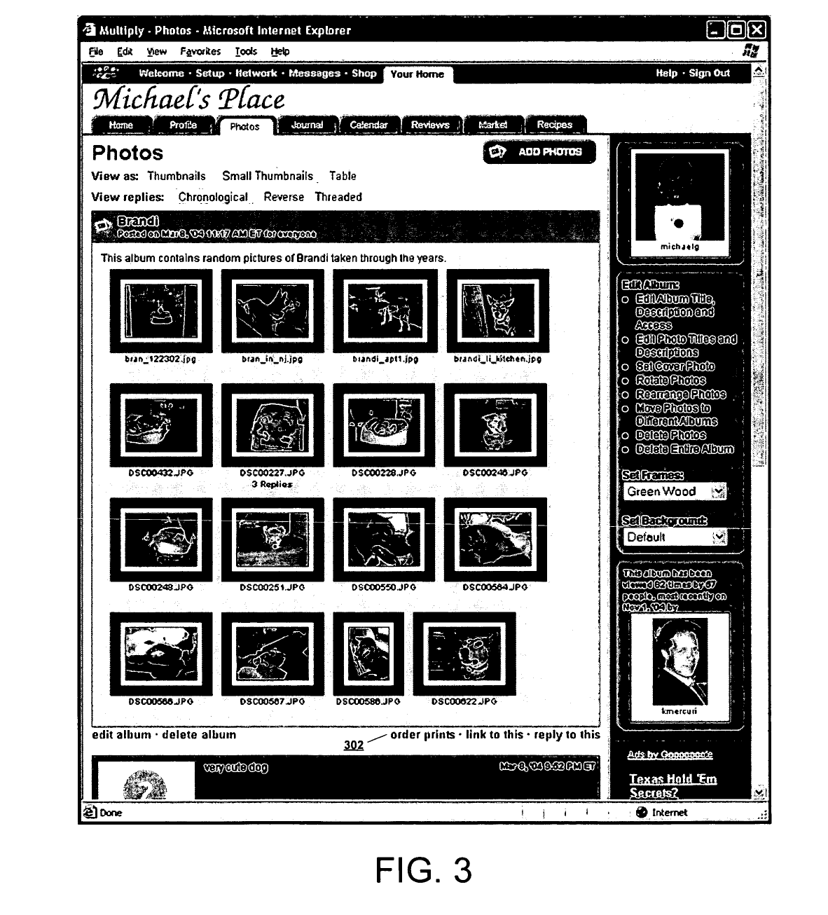

FIG. 3 depicts an exemplary photograph album in a social networking environment. When viewing a photograph album, a user may select an “Order Prints” link, button, icon, or similar designator 302 which denotes that the user would like to initiate a photo printing process. In an embodiment, the social networking environment may prevent the user from downloading the photograph to his or her computer and printing the photograph on a printer that the user designates. In an embodiment, the user may be permitted to download and print photographs displayed in the social networking environment.

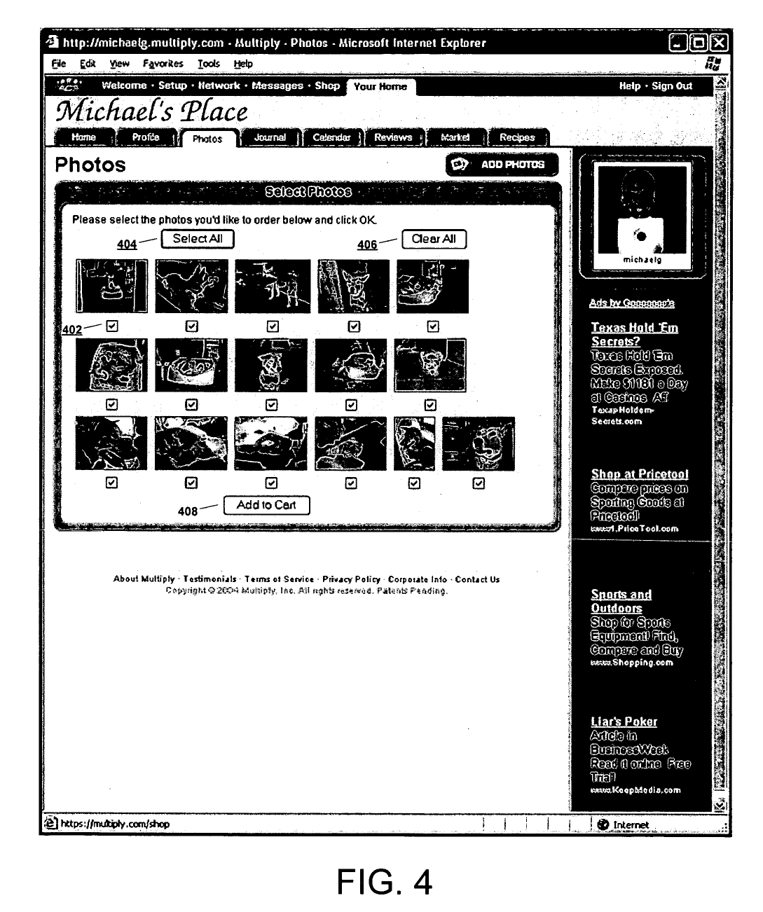

FIG. 4 depicts an exemplary photograph selection screen according to an embodiment. A selection screen permitting the user to select one or more photographs for printing may then be displayed. Only photographs that the user is permitted to have printed may be displayed for selection. Each permissible photograph may have a selectable box, icon or other designator, such as 402, that designates that the user has selected the photograph for printing. In an embodiment, a single icon, button, or other designator may be displayed to allow the user to select all 404 or clear all 406 permissible photographs in the album. Once the user has selected one or more photographs to print, the user may select, for example, an “Add to Cart” button 408 to continue the process.

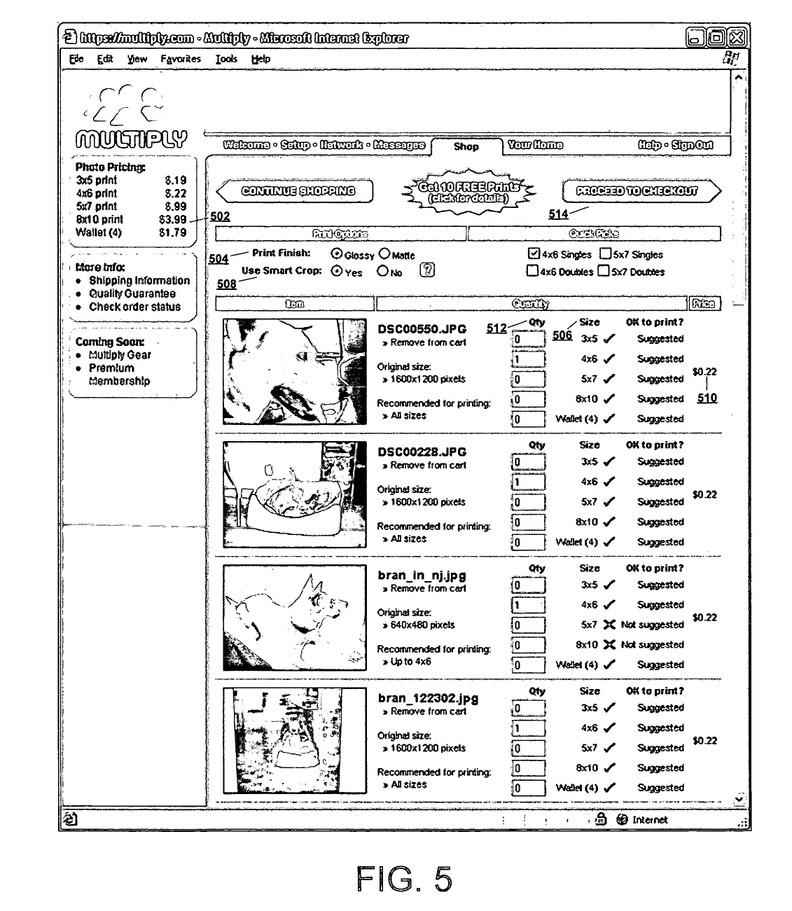

FIG. 5 depicts an exemplary photograph print option selection screen according to an embodiment. In FIG. 5, once a user has selected appropriate photographs, the social networking environment may display a screen including pricing information 502 and photograph options for the user. The photograph options may include, for example, selecting a print finish 504 (such as glossy or matte) for the selected photographs, the size(s), such as 506, of the selected photographs, and/or selecting whether cropping 508 of the selected photograph is performed automatically or manually, if required, based on, for example, the dimensions of the photograph and the requested size(s). In an embodiment, the user may be required to select one or more of the options for each selected photograph. In an alternate embodiment, the user may select the same options for all photographs. In an embodiment, the price 510 for having each selected photograph printed is tabulated based on the number of prints 512 and the size(s) of prints 506 requested for that photograph. In an embodiment, a total price is also displayed. Once the user is satisfied with his selected options, the user may “Proceed to Checkout” by selecting an appropriate designator 514.

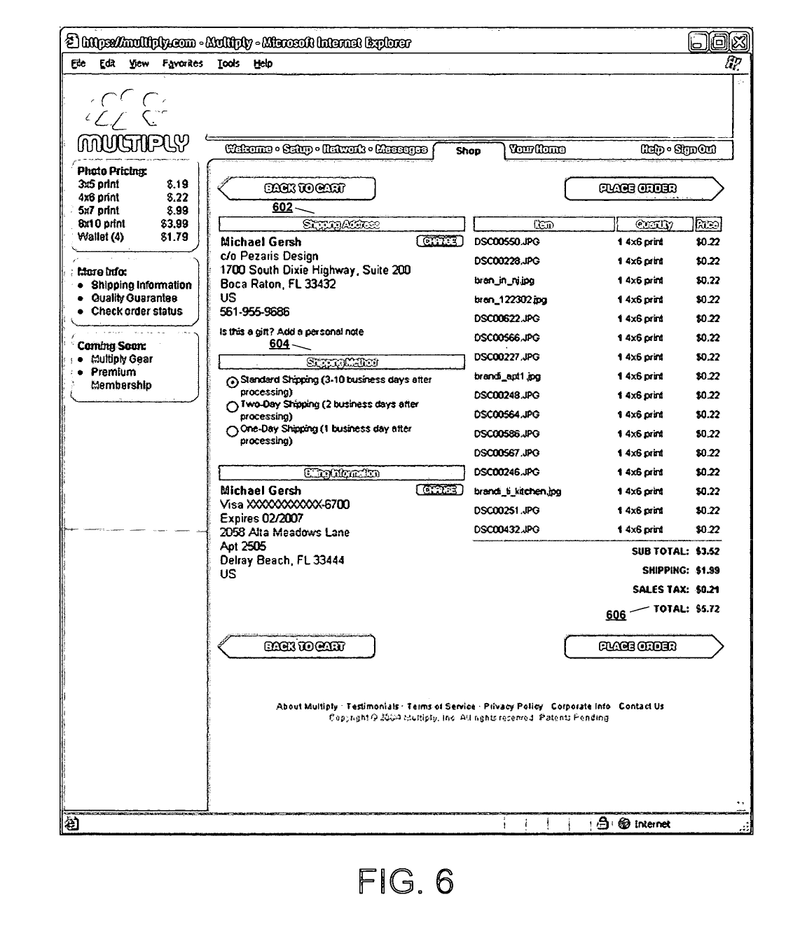

FIG. 6 depicts an exemplary shipping information screen according to an embodiment. As shown in FIG. 6, the user may determine a shipping address 602 and a shipping method 604 for shipping the prints of the photographs. The screen may further contain a total price for the prints including shipping costs 606.

Billing information may then be received from the user and the order may be submitted to, for example, a third party print service. The print service may be responsible for receiving the photographs, printing them, and shipping the printed photographs to the user-defined destination. In an alternate embodiment, an operator (or employee) of the social networking environment may print and ship printed photographs on behalf of the social networking environment. In an embodiment, digital versions of the photographs may be emailed to the user. In an embodiment, the photographs may be stored on one or more digital and/or analog portable media, such as a CD, DVD, video tape, diskette, and the like. The photographs may be stored in a BMP format, a JPEG format, a GIF format or any other picture format.

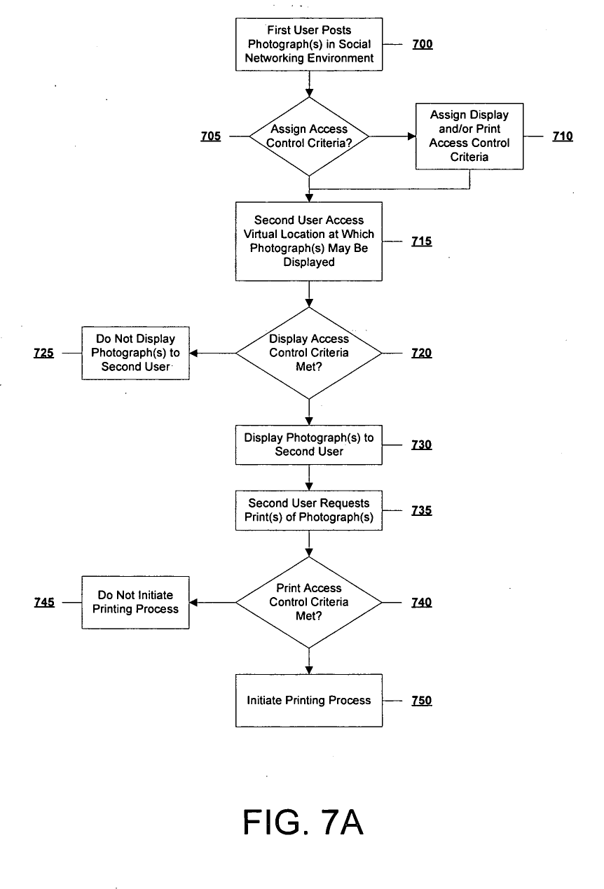

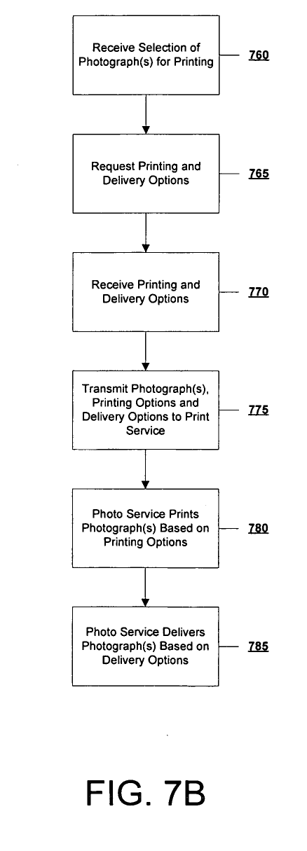

FIG. 7A depicts an exemplary method of providing access control according to an embodiment. A first user may post 700 one or more photographs in, for example, a photo album contained within the social networking environment. The first user may determine 705 whether to assign display access control criteria and/or print access control criteria to the photo album and/or to one or more photographs. If the user chooses to assign access control criteria, the pertinent access control criteria may be assigned 710. Each access control criteria may include, but is not limited to, a relationship designator, a group designator, a tier designator, a proximity index, a geographic location, a family name, and/or the like. The display and print access control criteria may be used to restrict access for displaying and printing the photographs and/or the photo album, respectively, to users having display information or print information corresponding to the access control criteria.

A second user may then access 715 the virtual location at which the photo album may be displayed. A determination 720 of whether the second user has a relationship with the first user that meets the display access control criteria, if any, assigned by the first user may then be made. If the second user's relationship does not meet the display access control criteria, the photo album and/or photographs may not be displayed 725 to the second user. Otherwise, the photo album and/or photographs may be displayed 730. The second user may then submit 735 a request to print one or more photographs. A determination 740 of whether the second user has a relationship with the first user that meets the print access control criteria, if any, assigned by the first user may be made. If the second user's relationship does not meet the print access control criteria, a printing process may not be initiated 745. Otherwise, a printing process, such as the one described below and depicted in FIG. 7B, may be initiated 750. In an embodiment, the social networking environment may display a link, button, or other designator enabling the second user to print one or more of the photographs only if the second user has a relationship with the first user that matches the print access control criteria.

FIG. 7B depicts an exemplary method for having one or more photographs printed from a social networking environment according to an embodiment. The social networking environment may receive 760 a selection of one or more photographs to be printed. The social networking environment may request 765 and receive 770 one or more of printing and delivery options for the photographs. Print options may include the quantity, size and finish (e.g., glossy or matte) of the photographs and whether and/or how the photographs should be cropped. Delivery options may include, for example, a shipping address, a billing address, a shipping method (e.g., next day air, ground, express, and/or regular delivery), and a payment method. The social networking environment may then transmit 775 the one or more photographs, the print options, and/or the delivery options to a print service. In an embodiment, the print service may be a third party print service. The photo service may print 780 the one or more photographs based on the print options. The photo service may then deliver 785 the one or more photographs based on the delivery options.

System Embodiment

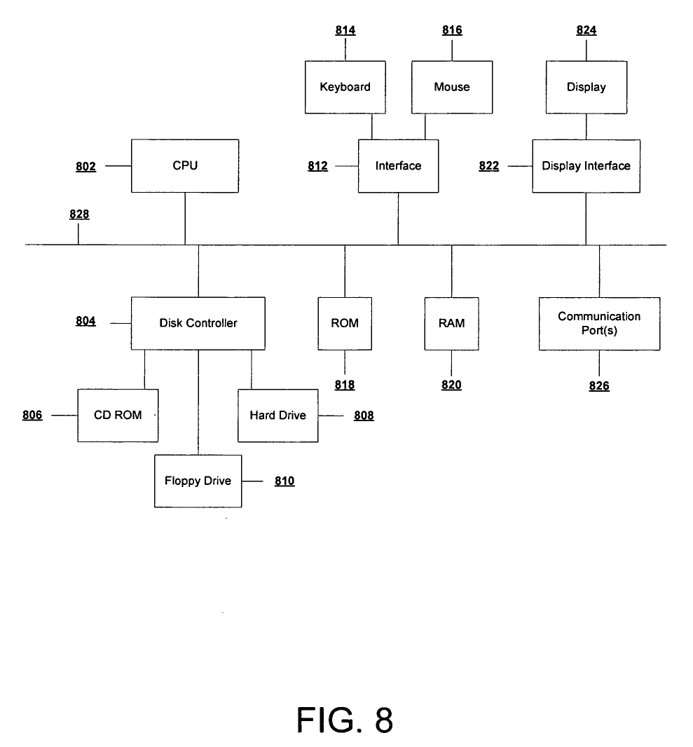

FIG. 8 depicts a block diagram of exemplary internal hardware that may be used to contain or implement program instructions according to an embodiment. Referring to FIG. 8, a bus 828 serves as the main information highway interconnecting the other illustrated components of the hardware. CPU 802 is the central processing unit of the system, performing calculations and logic operations required to execute a program. Read only memory (ROM) 818 and random access memory (RAM) 820 constitute exemplary memory devices.

A disk controller 804 may interface with one or more optional disk drives to the system bus 828. These disk drives may be external or internal floppy disk drives such as 810, CD ROM drives 806, or external or internal hard drives 808. As indicated previously, these various disk drives and disk controllers are optional devices.

Program instructions may be stored in the ROM 818 and/or the RAM 820. Optionally, program instructions may be stored on a computer readable medium such as a floppy disk or a digital disk or other recording medium, a communications signal or a carrier wave.

An optional display interface 822 may permit information from the bus 828 to be displayed on the display 824 in audio, graphic or alphanumeric format. Communication with external devices may optionally occur using various communication ports 826. An exemplary communication port 826 may be attached to a communications network, such as the Internet or an intranet. A plurality of user computers may be attached to the communication port 826 via the communications network to provide user access to a social networking environment.

In addition to the standard computer-type components, the hardware may also include an interface 812 which allows for receipt of data from input devices such as a keyboard 814 or other input device 816 such as a remote control, pointer and/or joystick.

An embedded system may optionally be used to perform one, some or all of the operations of the present invention. Likewise, a multiprocessor system may optionally be used to perform one, some or all of the operations of the present invention.

Although the invention has been described with reference to the preferred embodiments, it will be apparent to one skilled in the art that variations and modifications are contemplated within the spirit and scope of the invention. The drawings and description of the preferred embodiments are made by way of example rather than to limit the scope of the invention, and it is intended to cover within the spirit and scope of the invention all such changes and modifications.

1. A method for controlling access rights to one or more photographs in a social networking environment, the method comprising:
receiving, from a first user, print access control criteria for one or more photographs posted by the first user in a social networking environment; and
if print information for a second user with respect to the first user corresponds to the print access control criteria, permitting the second user to have at least one of the photographs printed.

2. The method of claim 1, further comprising:
if the print information for the second user does not correspond to the print access control criteria, preventing the second user from having the photographs printed.

3. The method of claim 1 wherein the print access control criteria comprise one or more of a relationship designator, a group designator, a tier designator, a proximity index, a geographic location, and a family name.

4. The method of claim 1 wherein the print information comprises one or more of a relationship designator, a group designator, a tier designator, a proximity index, a geographic location, and a family name.

5. The method of claim 1, further comprising:
receiving, from a first user, display access control criteria for the one or more photographs; and
if display information for a second user with respect to the first user corresponds to the display access control criteria, permitting at least one of the photographs to be displayed to the second user.

6. The method of claim 5, further comprising:
if the display information for the second user does not correspond to the display access control criteria, preventing the second user from accessing the photographs.

7. The method of claim 5 wherein the display access control criteria comprise one or more of a relationship designator, a group designator, a tier designator, a proximity index, a geographic location, and a family name.

8. The method of claim 5 wherein the display information comprises one or more of a relationship designator, a group designator, a tier designator, a proximity index, a geographic location, and a family name.

9. A method for enabling the printing of access-controlled photographs posted in a social networking environment, the method comprising:
receiving one or more access control criteria for one or more photographs from a first user;
displaying the one or more photographs posted by the first user in a social networking environment;
receiving a first request to have at least one photograph printed;
receiving a second request to assign one or more print options for each photograph requested by the first request;
receiving a third request to assign one or more delivery options for the at least one photograph requested by the first request; and
providing the at least one photograph requested by the first request to a print service.

10. The method of claim 9 wherein displaying the one or more photographs is based on at least the access control criteria.

11. The method of claim 9 wherein the first request is received from a second user.

12. The method of claim 11 wherein the first request is received based on at least the access control criteria.

13. The method of claim 9 wherein the one or more print options comprise one or more of the following:
a print finish option;
a cropping option;
one or more quantities to have printed for each photograph requested by the first request;
one or more print sizes for each photograph requested by the first request; and
a quantity to have printed for each photograph requested by the first request for each of one or more print sizes.

14. The method of claim 9 wherein the second request is received from a second user.

15. The method of claim 9 wherein the one or more delivery options comprises one or more of the following:
a billing address;
a delivery address;
a shipping method; and
a payment method.

16. The method of claim 9 wherein the third request is received from a second user.

17. The method of claim 9, further comprising receiving a first payment for having the at least one photograph requested by the first request printed.

18. The method of claim 16, further comprising transmitting a second payment to the print service for printing the at least one photograph requested by the first request.

19. The method of claim 9 wherein providing the at least one photograph requested by the first request comprises transmitting the at least one photograph to a print service.

20. The method of claim 9, further comprising:
printing, by the print service, the at least one provided photograph based on the one or more print options; and
delivering the at least one printed photograph based on the one or more delivery options.

21. A method for having access-controlled photographs printed in a social networking environment printed, the method comprising:
determining, by a social networking environment, whether a user has a right to access at least one photograph;
if the user has the right to access the at least one photograph, displaying the at least one photograph to the user;
receiving, by the social networking environment, a request from the user to have one or more access-controlled photographs printed;
receiving, by the social networking environment, one or more print options for printing the one or more photographs and one or more delivery options for delivering at least one print of the one or more photographs;
providing the one or more photographs to a print service;
printing, by the print service, the one or more photographs based on the one or more print options; and
delivering the one or more prints of the one or more photographs based on the one or more delivery options.

22. A system for controlling access rights to one or more photographs in a social networking environment, the system comprising:
a processor;
a computer-readable storage medium in communication with the processor;
a communications network operably connected to the processor; and
a plurality of computer systems operably connected to the communications network,
wherein the computer-readable storage medium contains one or more programming instructions for performing a method for controlling access rights to one or more photographs in a social networking environment, the method comprising:
receiving, from a first user, print access control criteria for one or more photographs posted by the first user in a social networking environment, and
if print information for a second user with respect to the first user corresponds to the print access control criteria, permitting the second user to have at least one of the photographs printed.

23. The system of claim 22 wherein the computer-readable storage medium further contains one or more programming instructions for performing the following:
receiving, from a first user, display access control criteria for the one or more photographs; and
if display information for a second user with respect to the first user corresponds to the display access control criteria, permitting the second user to display at least one of the photographs.

24. A system for enabling the printing of access-controlled photographs posted in a social networking environment, the system comprising:
a processor;
a computer-readable storage medium in communication with the processor;
a communications network operably connected to the processor; and
a plurality of computer systems operably connected to the communications network,
wherein the computer-readable storage medium contains one or more programming instructions for performing a method for enabling the printing of access-controlled photographs posted in a social networking environment, the method comprising:
receiving one or more access control criteria for one or more photographs from a first user;
displaying one or more photographs posted by a first user in a social networking environment;
receiving a first request to have at least one photograph printed;
receiving a second request to assign one or more print options for each photograph requested by the first request;
receiving a third request to assign one or more delivery options for each photograph requested by the first request; and
providing each photograph requested by the first request to a print service.

25. A system for having access-controlled photographs printed in a social networking environment printed, the system comprising:
a processor;
a computer-readable storage medium in communication with the processor;
a communications network operably connected to the processor; and
a plurality of computer systems operably connected to the communications network,
wherein the computer-readable storage medium contains one or more programming instructions for performing a method for having access-controlled photographs printed in a social networking environment printed, the method comprising:
determining, by a social networking environment, whether a user has a right to access at least one photograph;
if the user has the right to access the at least one photograph, displaying the at least one photograph to the user;
receiving, by the social networking environment, a request from the user to have one or more access-controlled photographs printed;
receiving, by the social networking environment, one or more print options for printing the one or more photographs and one or more delivery options for delivering at least one print of the one or more photographs;
providing the one or more photographs to a print service;
printing, by the print service, the one or more photographs based on the one or more print options; and
delivering the one or more prints of the one or more photographs based on the one or more delivery options.
